(19) United States
(12) Patent Application Publication
(10) Pub. No.: US 2008/0030466 A1
(43) Pub. Date: Feb. 7, 2008

(54) System and method for correcting positioning and triggering errors for aim-and-trigger devices

(76) Inventors: Leigh Simeon Keates, Mahopac, NY (US); Peter Kenneth Malkin, Ardsley, NY (US); Sharon Mary Trewin, Croton-on-Hudson, NY (US)

Correspondence Address: KEUSEY, TUTUNJIAN & BITETTO, P.C., 20 CROSSWAYS PARK NORTH, SUITE 210, WOODBURY, NY, 11797, US

(21) Appl. No.: 11/498,885

(22) Filed: Aug. 3, 2006

(51) Int. Cl. G09G 5/08

(52) U.S. Cl. 345/158

(57) ABSTRACT

A system and method for correcting mispositioning of an aiming device including extracting features from an information stream which includes position information for an aiming device and comparing the features with feature profiles to determine modifications to remediate mispositioning actions. The information stream with the modifications is provided as a basis for actions of the aiming device.

### BACKGROUND

1. Technical Field

The present invention relates to technology devices in which a human operator makes an aiming motion using an aiming device, and uses an associated trigger to cause an action to take place, and more particularly, to techniques for reducing aiming and triggering errors.

2. Description of the Related Art

When a human makes a precise aiming movement with a device (e.g., a computer mouse), slips and jerks may affect the position being aimed at. Slips and jerks are defined as sudden uncontrolled and unintended movements. A slip may be defined as a small movement while a jerk may be defined as a larger, longer movement. Slips and jerks may originate from the human's motor control system, or from the environment in which the human is operating. Additionally, when the device also incorporates a trigger (e.g., a mouse button), these slips and jerks may result in the trigger being unintentionally activated, activated in the wrong position, or not activated when desired.

Where the aim-and-trigger device is a computer mouse, this leads to input errors with selections made in the wrong place, unintended selections being made, selections being missed, and the user losing track of the position of the cursor. When the device is a camera, the result may be unwanted, blurry or badly composed photographs, or missed photographs. When the device is a weapon, the result may be that the target is missed, or an unintended area is hit.

Damping mechanisms or firm mounting devices may be used to minimize slips or jerks, but these can make the device more unwieldy. High resistance can be added to the trigger to reduce accidental trigger actions, but again this makes deliberate trigger actions more difficult to make. On a computer mouse, adjustments can be made to the function that transforms physical mouse movement to on-screen cursor movement. This may reduce the effect of slips and jerks, but will not correct them, and will affect the sensitivity of the device as a whole such that greater effort is required to make pointing actions.

It would be desirable to provide a mechanism for correcting slips, jerks and trigger actions that does not reduce the flexibility and sensitivity of the aim-and-trigger device.

### SUMMARY

Disclosed are systems and methods for correcting mispositioning of an aiming device including extracting features from an information stream which includes position information for an aiming device and comparing the features with feature profiles to determine modifications to remediate mispositioning actions. The information stream with the modifications is provided as a basis for actions of the aiming device.

These and other features and advantages of the invention will become apparent from the following detailed description of illustrative embodiments thereof, which is to be read in connection with the accompanying drawings.

### BRIEF DESCRIPTION OF DRAWINGS

The disclosure will provide details in the following description of preferred embodiments with reference to the following figures wherein:

FIG. 1 is an overview of a system employing techniques of an embodiment in accordance with present principles;

FIG. 2 is a high level block/flow diagram depicting exemplary method steps for initiating, executing and terminating one embodiment in accordance with present principles;

FIG. 3 is a high level block/flow diagram depicting exemplary method steps for processing events, including analyzing and handling slips, jerks and unwanted trigger actions in an input stream relating to an ‘aim-and-trigger’ device;

FIG. 4 is a block/flow diagram of exemplary detailed method steps for handling slips;

FIG. 5 is a block/flow diagram of exemplary detailed method steps for handling jerks;

FIG. 6 is a block/flow diagram of exemplary detailed method steps for handling trigger actions; and

FIG. 7 is an exemplary block/flow diagram for the production of a stream of modified events subsequent to the processing performed by the slip, jerk and trigger action handlers.

### DETAILED DESCRIPTION OF PREFERRED EMBODIMENTS

Embodiments in accordance with present principles includes systems and methods by which a data processing system can provide assistance to a user of a device such as a computer pointing device, camera, video camera, weapon, etc. in which the user moves the device to locate a target and then initiates a trigger action. An aiming device may be defined as a device employed to aim a cursor, indicator or cross-hair onto a target. The embodiments provide compensation for the effect of slips and jerks on the aiming activity, and on the associated trigger activity.

In a particularly useful embodiment, a method includes receiving from the user-controlled aiming device a time-stamped information stream that includes position information describing the position being pointed at by the device. Other information including position, velocity and acceleration information for the device itself and for the position pointed at by the device may also be used. Specific features are extracted from the information stream and a comparison of the specific features and typical feature profiles are created. Modifications to the information stream are computed based on the comparison so as to remediate slips, jerks or trigger actions. The modified information stream is returned (in real-time) as the basis for further actions.

The user moves the aiming device (e.g., a computer mouse) while the data processing system monitors the position of the pointing movement, and the position, velocity and acceleration of the aiming device itself. The position of the pointing movement identifies a location in a real or virtual environment. The data processing system calculates the velocity and acceleration of the pointing movement, based on the position and time data received. It analyses the position, velocity and acceleration characteristics of the pointing movement, and of the movement of the device itself. It does this by comparing their recent profiles with the characteristics of normal movement, and with the characteristics of slips and jerks. User profile data including movement characteristics typical of the current user may also be employed in this analysis.

In one preferred embodiment, analysis could take the form of a Bayesian network that acts to calculate and combine probabilities for characteristics of slips, jerks and unintended/missed trigger actions being present. For example, a recent profile in which the pointed-at location was steady for a short time, then the pointer accelerated away and a trigger action was initiated during this movement is suggestive of the presence of a slip. This, combined with other evidence, gives a probability of the presence of a slip. Other analysis techniques such as neural networks could also be employed.

When the analysis suggests that a slip, jerk, or unwanted/missed trigger action has occurred, the data processing system filters the pointing movement and/or trigger information to intercept, reduce or eliminate the unwanted effect. It uses the same typical movement characteristics to achieve this. In the slip example, a slip could be deemed to start at the point of acceleration prior to the trigger action. These filtered events are passed on to the system being controlled (e.g., the computer). If no slips or jerks are detected, the pointing device movement is passed unchanged on to the system being controlled.

Embodiments of the present invention can take the form of an entirely hardware embodiment, an entirely software embodiment or an embodiment including both hardware and software elements. Some embodiments may be implemented in software, which includes but is not limited to firmware, resident software, microcode, etc.

Furthermore, the invention can take the form of a computer program product accessible from a computer-usable or computer-readable medium providing program code for use by or in connection with a computer or any instruction execution system. For the purposes of this description, a computer-usable or computer readable medium can be any apparatus that may include, store, communicate, propagate, or transport the program for use by or in connection with the instruction execution system, apparatus, or device. The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk-read only memory (CD-ROM), compact disk-read/write (CD-R/W) and DVD.

A data processing system suitable for storing and/or executing program code may include at least one processor coupled directly or indirectly to memory elements through a system bus. The memory elements can include local memory employed during actual execution of the program code, bulk storage, and cache memories which provide temporary storage of at least some program code to reduce the number of times code is retrieved from bulk storage during execution. Input/output or I/O devices (including but not limited to keyboards, displays, pointing devices, etc.) may be coupled to the system either directly or through intervening I/O controllers.

Network adapters may also be coupled to the system to enable the data processing system to become coupled to other data processing systems or remote printers or storage devices through intervening private or public networks. Modems, cable modem and Ethernet cards are just a few of the currently available types of network adapters.

Other embodiments may be implemented in an integrated circuit chip. The chip design may be created in a graphical computer programming language, and stored in a computer storage medium (such as a disk, tape, physical hard drive, or virtual hard drive such as in a storage access network). If the designer does not fabricate chips or the photolithographic masks used to fabricate chips, the designer transmits the resulting design by physical means (e.g., by providing a copy of the storage medium storing the design) or electronically (e.g., through the Internet) to such entities, directly or indirectly. The stored design is then converted into the appropriate format (e.g., GDSII) for the fabrication of photolithographic masks, which typically include multiple copies of the chip design in question that are to be formed on a wafer. The photolithographic masks are utilized to define areas of the wafer (and/or the layers thereon) to be etched or otherwise processed.

The resulting integrated circuit chips can be distributed by the fabricator in raw wafer form (that is, as a single wafer that has multiple unpackaged chips), as a bare die, or in a packaged form. In the latter case the chip is mounted in a single chip package (such as a plastic carrier, with leads that are affixed to a motherboard or other higher level carrier) or in a multichip package (such as a ceramic carrier that has either or both surface interconnections or buried interconnections). In any case the chip is then integrated with other chips, discrete circuit elements, and/or other signal processing devices as part of either (a) an intermediate product, such as a motherboard, or (b) an end product. The end product can be any product that includes integrated circuit chips, ranging from toys and other low-end applications to advanced computer products having a display, a keyboard or other input device, and a central processor.

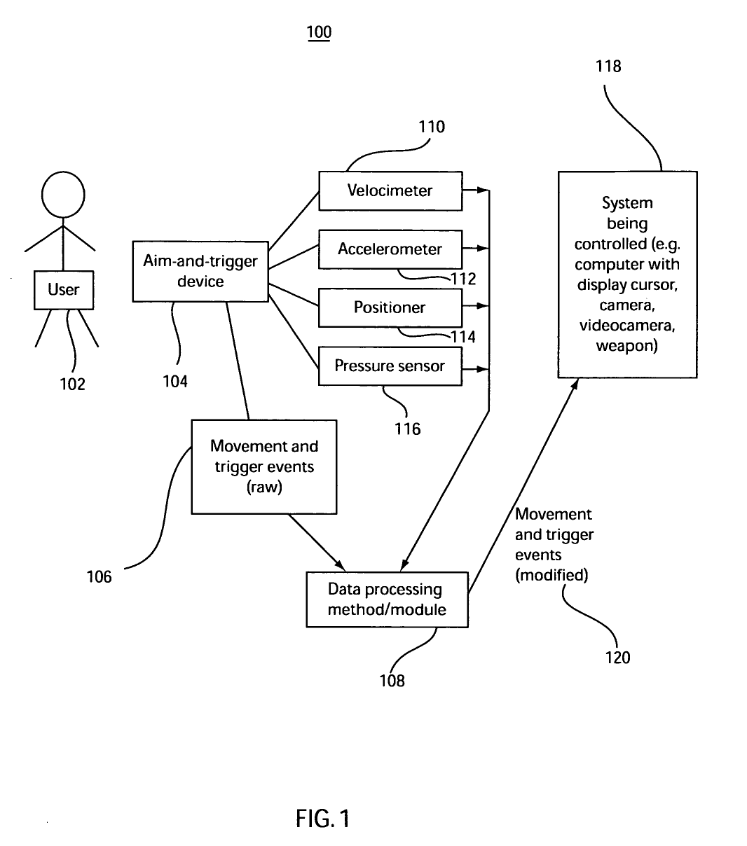

Referring now to the drawings in which like numerals represent the same or similar elements and initially to FIG. 1, a system 100 illustratively depicts components involved in an interaction in accordance with the present principles. A user 102 may have a disability that affects motor control, or may be in a situation that affects his or her abilities to properly use an aim-and-trigger device 104 (e.g., riding in a car affects your ability to operate a computer pointing device). The aim-and-trigger device 104 is preferably user operated, although robotic arms or other ways of activating the aim-and-trigger device 104 are also contemplated.

The aim-and-trigger device 104 may be a specialized external physical device such as an external computer mouse, trackball or joystick that can be plugged into a computer, or aim-and-trigger device 104 may be an integral part of a computer-based device that is held and aimed by the user 102 such as a camera, video camera or a weapons system. The aiming and triggering functions may be co-located or separate (on separate components or positions of the same device). There may be more than one aiming device and more than one trigger. The illustrative device 104 (or set of devices) produces a stream of movement information and trigger events 106 that are processed using a data processing method or module 108. This stream 106 of information describes the position pointed at by the aiming device 104. It may also include higher-order information such as velocity and acceleration information. In addition to the movement information and trigger events, the aiming device or devices 104 may have associated velocimeter(s) 110, accelerometer(s) 112, positioning system(s) 114, pressure sensor(s) 116 (to detect the presence of a user's hand etc.) and other sensors that provide additional information about the physical movement of the device in space, its position, velocity and acceleration, and the movements of the user who is controlling the device. This information may be employed by module 108.

Module 108 processes this information and produces a modified stream 120 of movement information and trigger events that is passed on to a system 118 that is being controlled via the ‘aim-and-trigger’ device 104. This may be a computer system, in which the movement is used to control an on-screen cursor, and the trigger events are mouse clicks. It may be a camera, in which the movement describes the direction in which the camera is pointing, and the trigger events are used to identify images to be captured as photographs, etc.

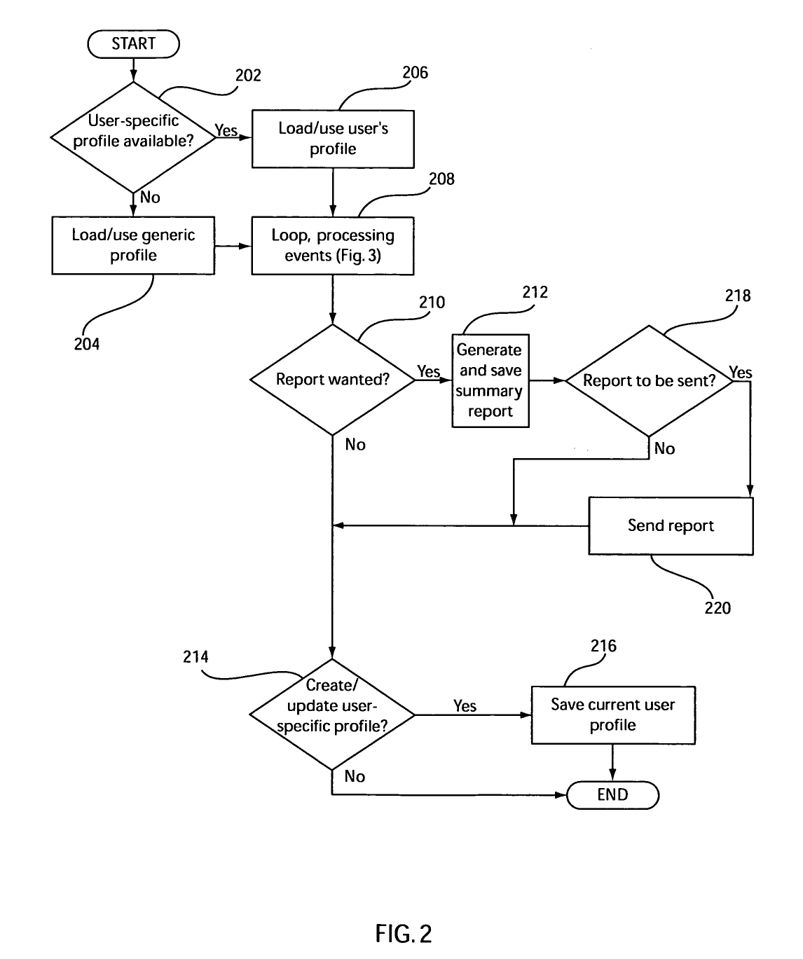

Referring to FIG. 2, an overview of operations of module 108 (FIG. 1), from activation to termination, is illustratively depicted. When activated, the module 108 checks whether a user-specific profile is available in block 202. This may be performed by querying a current user, or by referring to stored preference information. Either a user-specific profile is loaded in block 206, or a generic default profile is used in block 204. A user profile may initially be created by a third party, copied from a stereotypical template, created by a specific training program operated by the user, or by any other means of initialization.

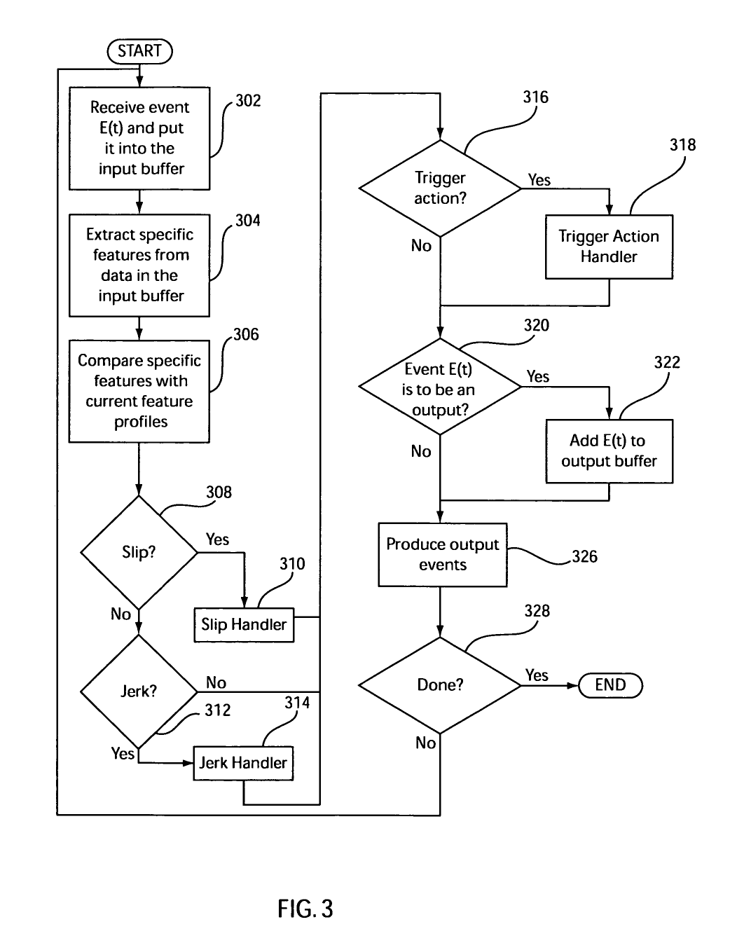

Once the profile has been loaded in block 206, the method loops in block 208, receiving events from the ‘aim-and-trigger’ device(s) 104 (FIG. 1), and producing a modified stream of events. This process will be described in greater detail with reference to FIG. 3. When the loop has terminated, the method may, if indicated in the current preferences in block 210, generate a summary report, in block 212, which describes the characteristics of the input stream, describes the modifications made to the input stream, or provides summary information on the actions taken with the aim-and-trigger device. In block 218, if indicated in the current preferences, the report will be sent to a third party in block 220. For example, reports may automatically be sent to the device manufacturer to inform future choices about default movement parameters for the aim-and-trigger device. In block 214, if indicated in the current preferences, a user-specific profile will be created, or the current profile updated, and this will be saved for future use before the method terminates in block 216.

Referring to FIG. 3, an event processing loop of module 108 (FIG. 1) is shown in accordance with one embodiment. In block 302, all incoming events (where “E(t)” indicates an event received at time “t” (e.g., time-stamping) are stored in an input buffer for access during later processing. In block 304, using this input buffer, specific features are extracted from the data. These features include information such as the current velocity and acceleration of the aim-and-trigger device itself, and the location being pointed at, the presence of trigger events, recent patterns of velocity and direction of movement, etc. In block 306, this information is compared with information in a current feature profile (user-specific or generic) that describes the features expected for normal movement, for slips and jerks, and for intentional, unintentional and missing trigger events.

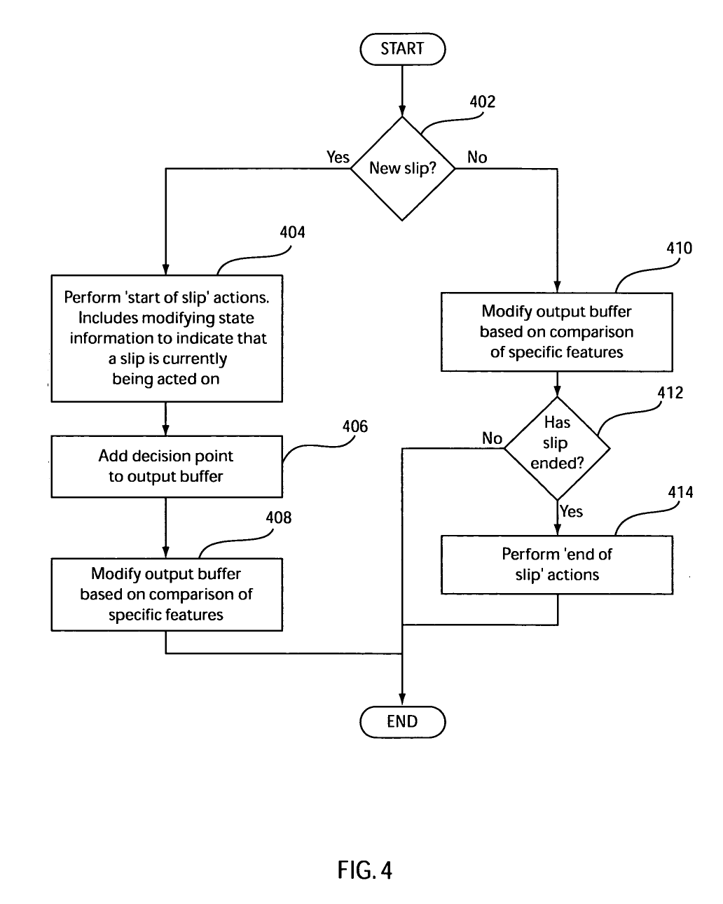

In block 308, if the comparison indicates that a slip is in progress, a slip handler method 310 is applied (see FIG. 4). For example, a slip may be identified when the location being pointed at remains constant with zero velocity for a specific period of time, and then both the pointed at location and the physical location of the ‘aim-and-trigger’ device start to move with high velocity, and a trigger event is initiated a short time after the start of this high velocity movement. This set of indicators could be described in the feature profile and associated with slipping actions. Several different slipping profiles may be present. A decision as to whether a slip has been detected may be made by comparing the current situation with a number of profiles that include slip and non-slip situations, calculating the degree of matching with each, and selecting the situation that most closely matches. Alternatively, probabilistic techniques such as a Bayesian network could be used to analyze the current inputs, and the user-specific profile could include a set of appropriate weights for the nodes of that network. Alternative implementations of the feature comparison step are also possible.

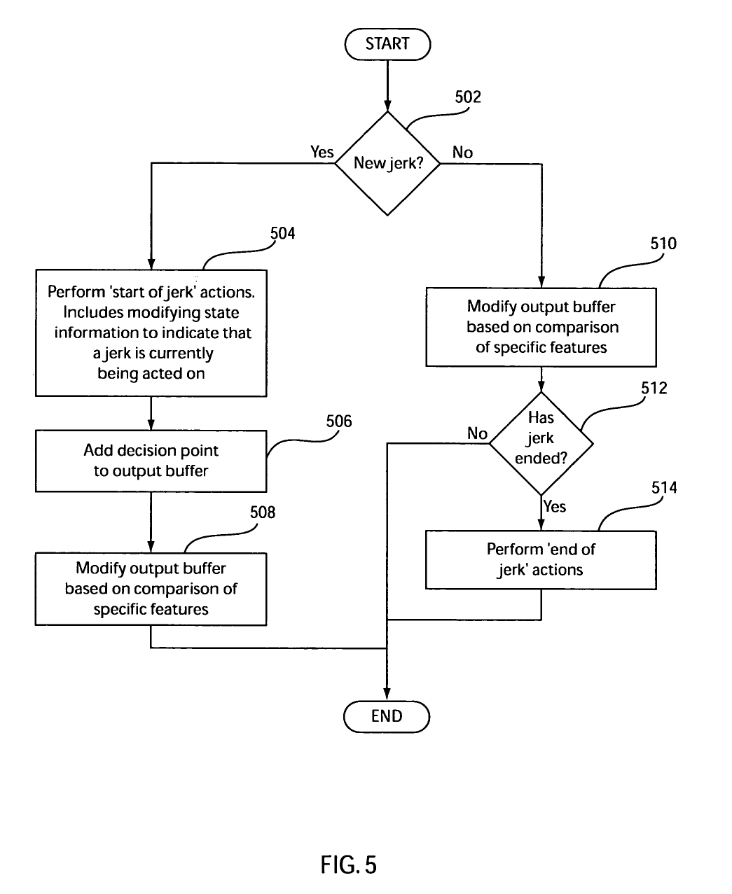

In block 312, detection of a jerk in the input would take a similar form. For example, a jerk could be identified by a situation in which the device's pointed-at location suddenly accelerates to a velocity higher than that for a normal aiming action. When a jerk is identified, the steps in a jerk handler 314 (see FIG. 5) are followed.

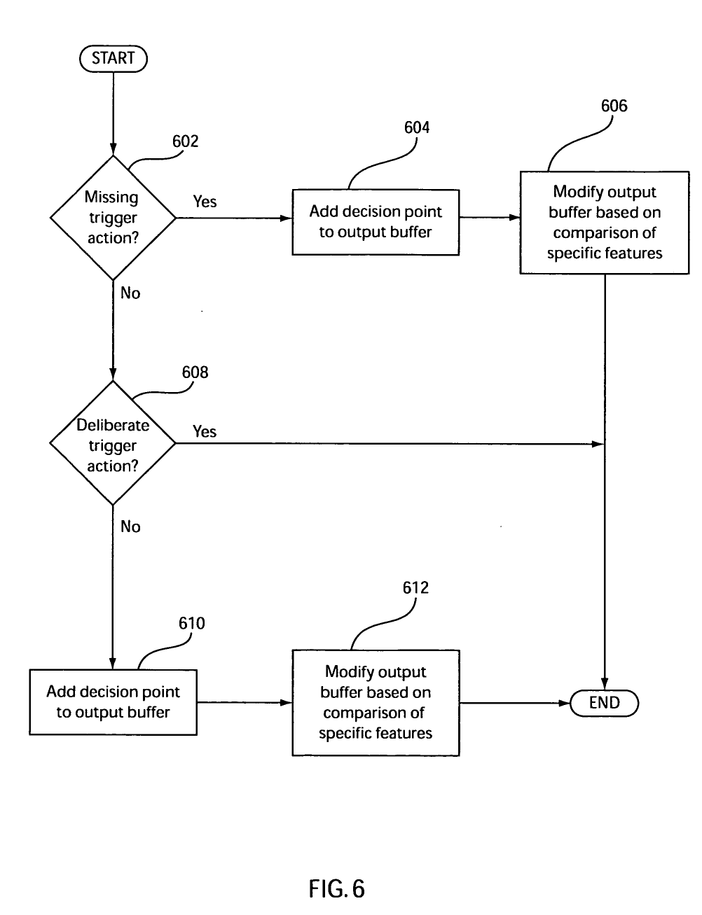

In block 316, when a trigger action is detected, the steps of a trigger action handler 318 (see FIG. 6) are followed. Trigger actions may be atomic (e.g. ‘fire now’) or separate ‘start trigger’ and ‘end trigger’ events (e.g., press and release of a mouse button). The trigger action handler 318 is also invoked when the comparison suggests that a trigger action was intended but not generated. For example, a computer user with motor impairment may click the mouse button by rolling their hand on to the button. Sometimes, their hand may slip off the mouse causing a distinctive movement to occur. Their user profile may capture this distinctive movement as an intended trigger action.

After all slip, jerk and trigger handlers have been executed, in block 320, the method tests whether the most recent event should be added to an output buffer in block 322. The output buffer provides temporary storage for events prior to their being released for further processing. In some embodiments, all events received by the method may be candidates for output. In other implementations, only events indicating the pointed-at location, or trigger events may be passed on. For example, when the method is used to filter computer mouse events, only position and trigger events are produced. Output of events may be suppressed if the slip, jerk and trigger event handlers determine that the current event should not be output.

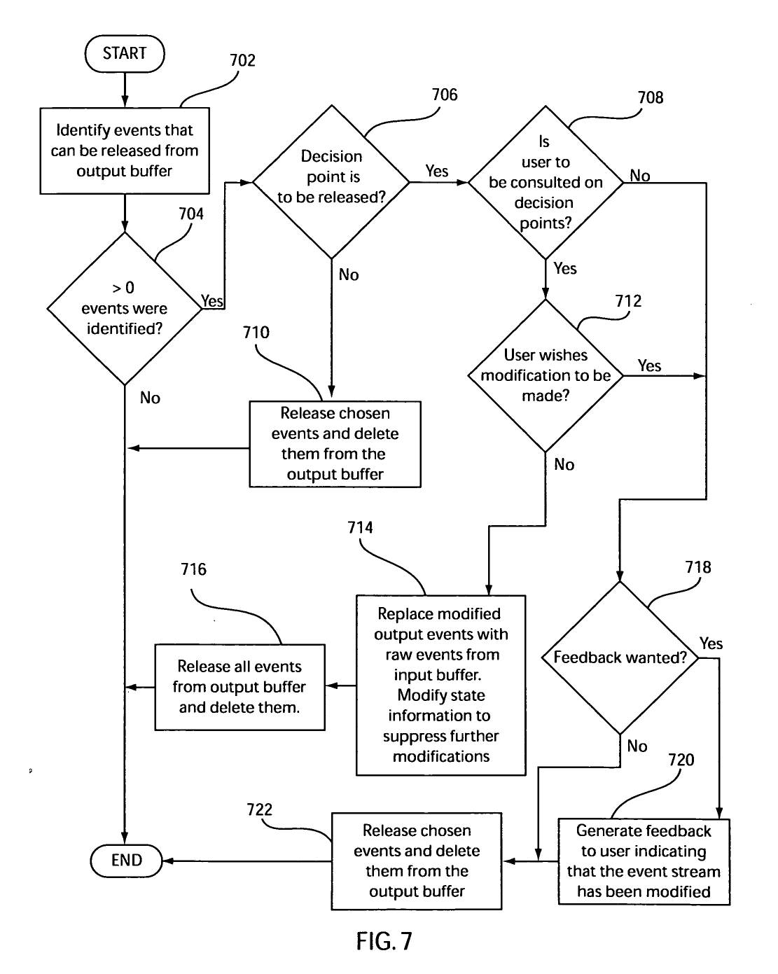

If the current event is to be output, it is added to the output buffer in block 322. Output events to be released are then chosen in block 326 as described more fully with reference to FIG. 7. The method then checks whether looping is done in block 328. If not, the next event is received and processing continues with block 302. This check for completion may involve checking for user commands, timers, system commands or other commands and events that cause the method to terminate. At this point other actions may also be taken, such as checking whether the user's performance has crossed some threshold and generating an alert when a threshold is crossed. This alert may, for example, provide the user with performance information that indicates how effective their current medical treatment is, and alerts them when additional medication may be necessary.

Referring to FIG. 4, a program path followed by slip handler 310 (FIG. 3) is illustratively shown for when a slip is detected, or has previously been detected, and the end of the slip has not yet been processed. When a new slip is detected in block 402, the current state information is modified, to indicate that a slip is being acted on in block 404. While a slip is being acted upon, all passes through the loop in FIG. 3 will follow the steps in slip handler 310. Other actions specific to the start of a slip may also be performed, such as updating summary information for the session, for the production of a performance report.

A ‘decision point’ is placed into the output buffer in block 406. This is a pseudo-event that marks the point in the event stream where a modification of the raw input events starts. It is used as illustrated in FIG. 7 in situations where the user is to be queried before making any modifications. It may also be used as an indicator of when to provide feedback to the user, indicating that a slip has been detected and the input stream is being modified.

After insertion of the decision point into the output buffer in block 406, the contents of the output buffer are modified to represent idealized outputs that would have been expected if no slip were present in block 408. This may involve adding events to the end of the buffer, inserting events into the buffer, modifying existing events, or deleting existing events. For example, when a slip is detected for a computer mouse, one preferred response would be to suppress all movement events during the slip. Modification of the output buffer may also involve adding new pseudo-events to the buffer that can be used in later processing. For example, when a slip is detected in the use of a camera, a pseudo-event indicating the position prior to the start of the slip could be inserted. The camera software could then retain the image that was recorded at that position.

If the user presses the camera shutter causing a trigger event while the slip is still in progress, the camera could offer the user a choice between the previously saved image and the image at the time of the shutter press. The earlier image may be closer to their intended photograph than the (possibly blurred) image they would have recorded.

If a slip has previously been detected and a new event is received, the method will again modify the output buffer as above, to reflect the inferred position that the user wanted in block 410. Next, a check is made to see whether the slip has ended in block 412. If so, then ‘end of slip’ actions are performed in block 414. This may include updating the current state information to indicate that no slip is currently being acted on.

Referring to FIG. 5, a program path followed by jerk handler 314 (FIG. 3) is illustratively shown for when a jerk is detected, or has previously been detected and the end of the jerk has not yet been processed. When a new jerk is detected in block 502, the current state information is modified in block 504 to indicate that a jerk is being acted on. While a jerk is being acted upon, all passes through the loop in FIG. 3 will follow the steps in the jerk handler 314. Other actions specific to the start of a jerk may also be performed, such as updating summary information for the session, for the production of a performance report. A jerk may initially be identified as a slip. When the jerk is identified, the ‘start of jerk’ actions include modification of the state information to indicate that no slip is in progress. A ‘decision point’ as described for FIG. 4 is placed into the output buffer in block 506. After insertion of the decision point into the output buffer, in block 508, the contents of the output buffer are modified to represent idealized outputs that would have been expected if no jerk were present, as described for FIG. 4.

If a jerk has previously been detected and a new event is received, in block 510, the method will again modify the output buffer as above, to reflect the inferred position that the user wanted. Next, a check is made to see whether the jerk has ended in block 512. If so, then ‘end of jerk’ actions are performed. This includes updating the current state information to indicate that no jerk is currently being acted on in block 514.

Referring to FIG. 6, a program path followed when a trigger action is received, when a trigger action is in progress (started but not completed), or when a missing trigger action is detected is illustratively presented. In block 602, when a missing trigger action is detected, a decision point is inserted into the output buffer in block 604, and the contents of the output buffer are modified to insert the missing trigger action(s) in block 606.

When a deliberate, correct trigger action is detected in block 608, no action is taken (the trigger event is placed into the output buffer unmodified as shown in FIG. 3). If the trigger event was not intentional, a decision point is added to the output buffer in block 610, and the content of the output buffer is modified to reflect the inferred action intended by the user in block 612. For example, if the pointed-at location for a computer mouse is changing rapidly and a trigger action is detected, this could be interpreted as an unintentional mouse click, and eliminated from the input stream. As a second example, if information from a pressure sensor indicates that the click coincides with the user placing their hand on the mouse, this may suggest that the click was unintentional.

Referring to FIG. 7, a program path followed when releasing events from the output buffer on to the receiving system is illustratively shown. In block 702, a set of events that can be released is identified. This is the set of events that would not be modified by any of the steps of the slip, jerk or trigger event handlers, regardless of what future events may arrive. In block 704, if such events are identified, and if one of those events is a ‘decision point’ pseudo-event described previously, this indicates that modified events are about to be released in block 706.

If the user profile indicates that the user should be consulted before any event modifications, then the user is queried as to whether this particular modification is desired in block 708. For example, if a computer user has slipped while clicking the mouse, the system may allow the user to choose the desired click location, with the choices offered being the location actually clicked on, and the location inferred by the method. In block 712, if the user does not wish the modification to be made, the changes to the output buffer are reversed in block 714, so that the original actions are released from the buffer and passed on to the system. The state information is updated to suppress further modifications relating to the current slip, jerk or trigger action.

If the user permits modification, or the user is not to be consulted on modifications, then the user profile is again consulted to determine whether feedback to the user is needed in block 718, when modifications to the event stream are made. If so, then, in block 720, the feedback is generated and the chosen events are released from the output buffer and passed on to the receiving system in block 722. Feedback may take the form of an aural indicator, or may be represented by further pseudo-events in the output stream, to be acted upon by the receiving system. For example, the event stream could include instructions that modify the shape or appearance of an object on the location display (computer cursor, camera or weapon viewfinder). If, in block 706, the events to be released do not include a decision point, the events are simply released from the buffer in block 710.

When the input stream has been modified, some embodiments may use further user modeling techniques to assess whether the modification was successful. For example, if the location of a click was modified by suppression of a slip, the user's next clicking action may provide evidence as to whether the original or modified location was intended. This information may be used to further refine the handler algorithms, or update the user profile. For example, if a slip was detected and suppressed, causing a user click to be moved to a new location, but the user immediately clicked again in the original location, the weights of a Bayesian network, or the probabilities associated with a specific slip profile could be adjusted, to lower the probability of the movement observed being interpreted as a slip.

Having described preferred embodiments of a system and method for correcting positioning and triggering errors for aim-and-trigger devices (which are intended to be illustrative and not limiting), it is noted that modifications and variations can be made by persons skilled in the art in light of the above teachings. It is therefore to be understood that changes may be made in the particular embodiments disclosed which are within the scope and spirit of the invention as outlined by the appended claims. Having thus described aspects of the invention, with the details and particularity required by the patent laws, what is claimed and desired protected by Letters Patent is set forth in the appended claims.

What is claimed is:

1. A method for correcting mispositioning of an aiming device, comprising:
extracting features from an information stream having position information for an aiming device;
comparing the features with feature profiles to determine modifications to remediate mispositioning actions; and
providing a modified information stream including the modifications to remediate mispositioning actions to replace the information stream.

2. The method as recited in claim 1, wherein extracting features from an information stream includes extracting position information.

3. The method as recited in claim 1, wherein extracting features includes extracting at least one of velocity and acceleration.

4. The method as recited in claim 1, wherein comparing includes identifying slips and jerks in the information stream.

5. The method as recited in claim 1, wherein extracting features includes extracting time-stamped information.

6. The method as recited in claim 5, wherein extracting time-stamped information includes at least one of accelerometer data provided by an accelerometer attached to the aiming device, velocimeter data provided by a velocimeter attached to the aiming device, pressure data provided by a pressure sensor attached to the aiming device, and trigger status for a trigger.

7. The method as recited in claim 1, further comprising a trigger on the aiming device wherein the method further includes:
extracting features and comparing to feature profiles to identify one of unintentional changes to a trigger status, and intended changes to the trigger status that were not generated; and
correcting a time-stamped information stream in which the effect of unintended trigger status changes and missing trigger status changes are eliminated.

8. The method as recited in claim 1, further comprising providing feedback to a user indicating when a correction of an input stream has been performed.

9. The method as recited in claim 1, further comprising generating an alert to a user if a performance threshold is crossed.

10. The method as recited in claim 1, further comprising:
monitoring user actions;
inferring from the user actions whether a previous assessment of an action was accurate; and
adjusting parameters of comparison used and stored feature profiles to improve future performance.

11. The method as recited in claim 1, further comprising permitting a user to decide whether a correction takes place or not.

12. The method as recited in claim 1, further comprising updating the feature profiles by using user actions with the aiming device and a trigger.

13. The method as recited in claim 12, further comprising defining an initial user-specific feature profile in advance of the user starting to use the aiming device and trigger.

14. The method as recited in claim 12, further comprising generating a report summarizing user performance, the feature profiles that have been calculated, and corrections made.

15. The method as recited in claim 14, further comprising sending the report to a third party.

16. A computer program product for correcting mispositioning of an aiming device comprising a computer useable medium including a computer readable program, wherein the computer readable program when executed on a computer causes the computer to perform the steps of:
extracting features from an information stream having position information for an aiming device;
comparing the features with feature profiles to determine modifications to remediate mispositioning actions; and
providing a modified information stream including the modifications to remediate mispositioning actions to replace the information stream.

17. A system for correcting mispositioning of an aiming device, comprising:
an aiming device configured to provide data features to indicate position information for the aiming device; and
a data processing module configured to compare the data features with feature profiles to determine modifications to remediate mispositioning actions of the aiming device.

18. The system as recited in 17, wherein the aiming device includes one of a computer mouse, a track ball, a joystick, a camera, a video camera and a weapons system.

19. The system as recited in claim 17, wherein the aiming device includes at least one of an accelerometer, a velocimeter, a pressure sensor and a trigger.

20. The system as recited in claim 17, further comprising a trigger on the aiming device wherein trigger status is includes in the feature profiles and is used to identify one of unintentional changes to the trigger status, and intended changes to the trigger status that were not generated such that effects of unintended trigger status changes and missing trigger status changes are corrected.
